(19) United States
(12) Patent Application Publication
(10) Pub. No.: US 2004/0055015 A1
(43) Pub. Date: Mar. 18, 2004

(54) Method for setting up a connection and associated device for receiving interactive services

(76) Inventors: Laurent Lesenne, Acigne (FR); Fabien Battini, Thorigne Fouillard (FR); Bruno Dezenaire, Rennes (FR); Guillaume Audeon, Rennes (FR)

Correspondence Address: Joseph S Tripoli, Thomson Multimedia Licensing Inc, Patent Operations CN 5312, Princeton, NJ, 08543-0028, US

(21) Appl. No.: 10/399,425

(22) PCT Filed: Oct. 19, 2001
(86) PCT No.: PCT/FR01/03235

(30) Foreign Application Priority Data
Oct. 23, 2000 (FR) 00/13502

(51) Int. Cl. H04N 7/173

(52) U.S. Cl. 725/110; 725/112

(57) ABSTRACT

The invention relates to a method of establishing a connection between an receiver device and an interactive services server, characterized in that it comprises the steps, at the level of the said receiver device of:

determining a domain identifier;

searching for the domain identifier in a correspondence file comprising a plurality of domain identifiers and for each domain identifier connection parameters;

updating a connection configuration file for an application with the aid of the connection parameters corresponding to the domain identifier received;

initializing the connection on the basis of the configuration file.

A receiver implementing the process is also a subject of the invention.

The invention applies in television systems with broadcasting of interactive services.

The invention relates to a method of establishing a connection between an interactive device, in particular an interactive television receiver, and a server through a connection, as well as to such a receiver.

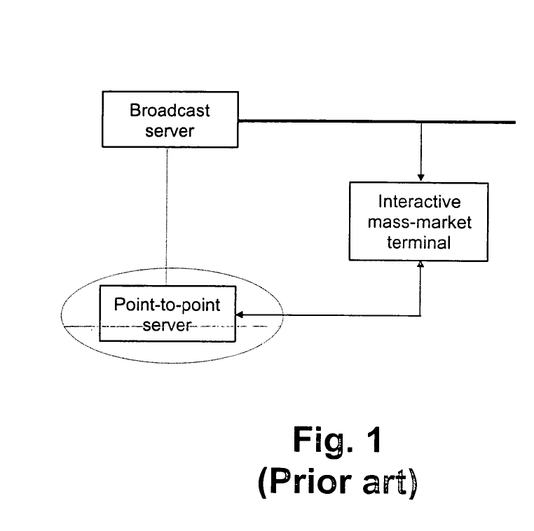

The present patent application comes within the framework of interactive television, enabling a user to interact with interactive services. The terminals are connected to one or more communication networks (see FIG. 1), for example:

a bidirectional network (return path by modem, cable, etc.) of point-to-point type, such as the telephone network;

a monodirectional distribution network (terrestrial TV, cable, satellite broadcasting network), analogue or digital.

The expression “interactive mass-market terminal” covers television receivers furnished with interactive modules, DVB decoders, Internet decoders, etc.

An interactive terminal is generally composed of resident software with which the manufacturer of the terminal associates downloading functions enabling the terminal to retrieve interactive services whether via the broadcast path or the return path. This resident software may be an interpreter executing applications or a browser interpreting scripts or HTML pages.

In certain interactive television systems, the terminal can be connected to on-line servers through the telephone network according to various charge rates. Thus, e-mail will for example be billed as local communication for the user of the terminal whereas a response sent in the course of a TV game may cost him the latter FF 3.71 for example. This principle relies on the use of various telephone numbers, each corresponding to a different charging level. The triggering of a connection at the browser level is transparent and relies on the principle of using a URL (“Uniform Resource Locator”). Specifically, a service merely needs to contain an instruction of the type: “window.location:=http://www.thmulti.com” in order for a connection to be established. The telephone number called, as well as other connection parameters, are specified in a configuration file (configuration.xml) which may be modified at will but through a particular interface. It should be added that to each telephone number there corresponds an authentication procedure which must allow the terminal to connect up by specifying certain connection parameters, such as a DNS (domain name), a connection word, a password, etc.

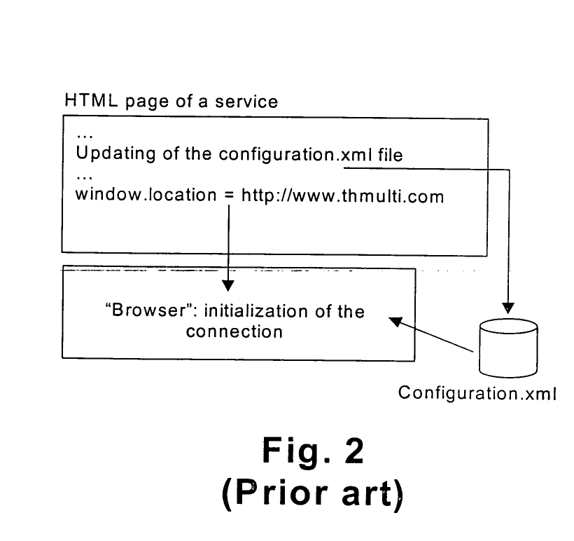

FIG. 2 illustrates this principle: an HTML page of an interactive service contains information for updating the configuration file ‘Configuration.xml’ for a connection. This updating is carried out. The HTML page moreover comprises a URL type link to this connection. If this link is activated, the HTML page indicates to the browser that the connection needs to be established. The browser then initializes the connection on the basis of the content of the configuration file.

Giving unrestricted access to this configuration file is relatively dangerous and the very principle of having to specify the telephone number as well as authentication parameters in the service seems to be onerous and above all prone to errors.

The subject of the invention is a method of establishing the connection between a receiver device and an interactive services server, characterized in that it comprises the steps, at the level of the said receiver device of:

determining a domain identifier;

searching for the domain identifier in a correspondence file comprising a plurality of domain identifiers and for each domain identifier connection parameters;

updating a connection configuration file for an application with the aid of the connection parameters corresponding to the domain identifier received;

initializing the connection on the basis of the configuration file.

The updating of the configuration file, on which the establishing of the connection to be made will be based, is triggered by the determination of a set of connection parameters, from among a plurality of sets. The configuration file is for example that of browser software, which will not have to be modified per se for the implementation of the invention.

According to the exemplary embodiment, the domain identifier, from which the correct set of connection parameters is determined, is a URL. The identifier can also index one of the parameter sets directly.

Other characteristics and advantages of the invention will become apparent through the description of a particular nonlimiting example explained with the aid of the adjoining figures among which:

FIG. 1, already described, is a block diagram of an interactive services transmission system known per se,

FIG. 2 is a prior art block diagram illustrating the extraction of connection parameters without connection interface,

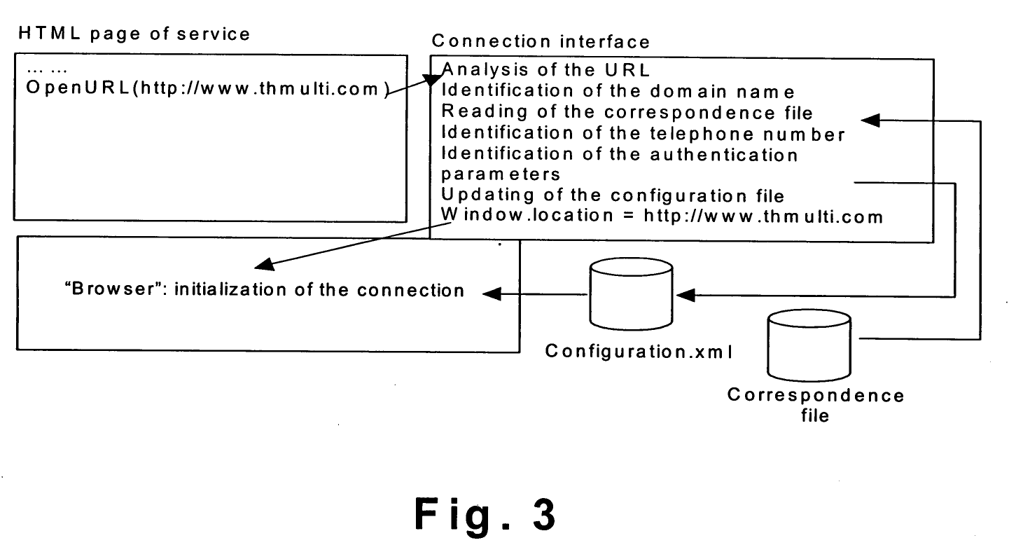

FIG. 3 is a block diagram illustrating the functioning of the connection interface for the extraction of the connection parameters,

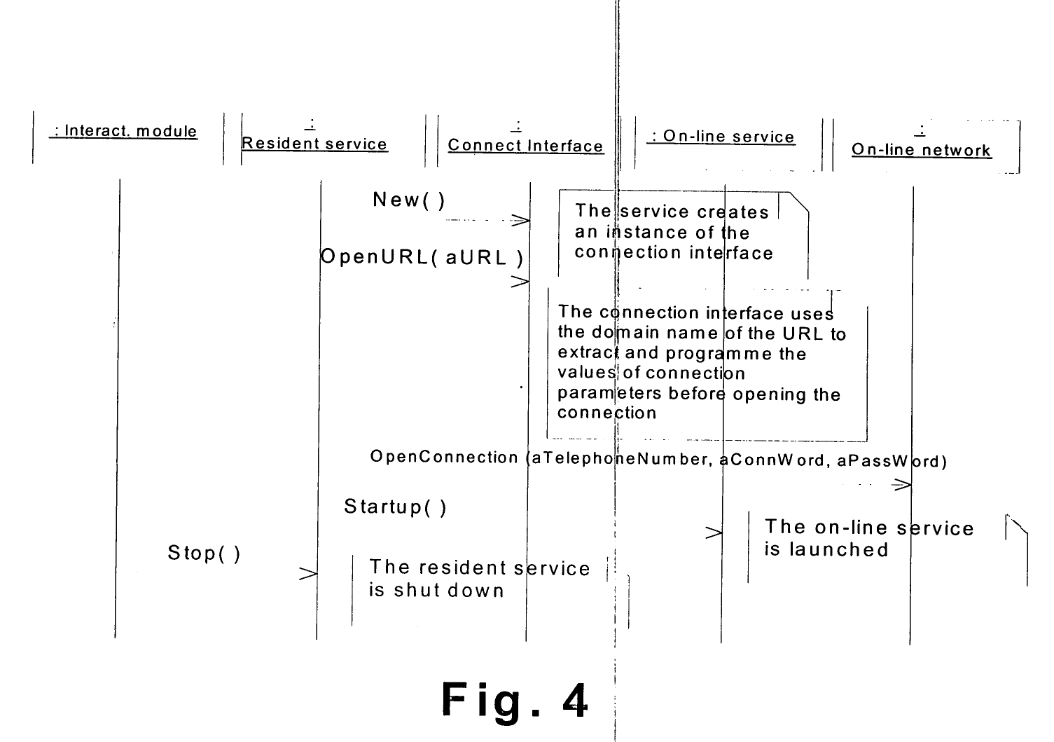

FIG. 4 illustrates the operations to be performed involving a resident service when an on-line service is to be launched,

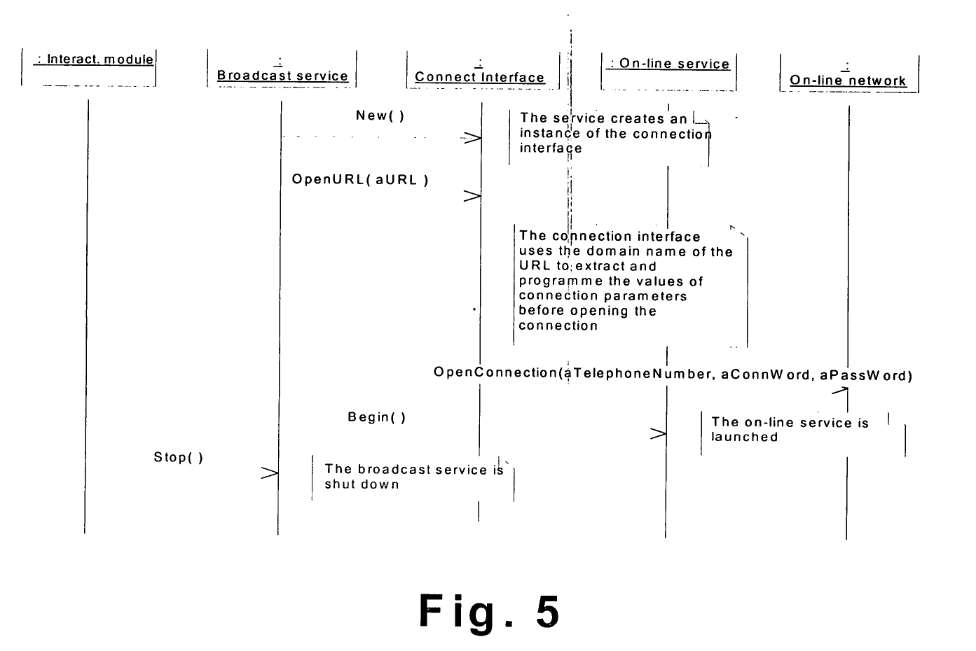

FIG. 5 illustrates the operations to be performed involving a radio broadcast service when an on-line service is to be launched,

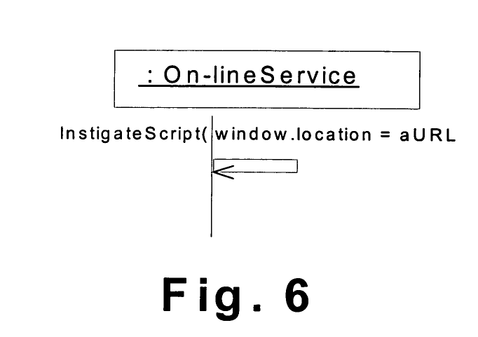

FIG. 6 illustrates the operation to be performed in order to change on-line interactive service when one is already connected to another service of this type,

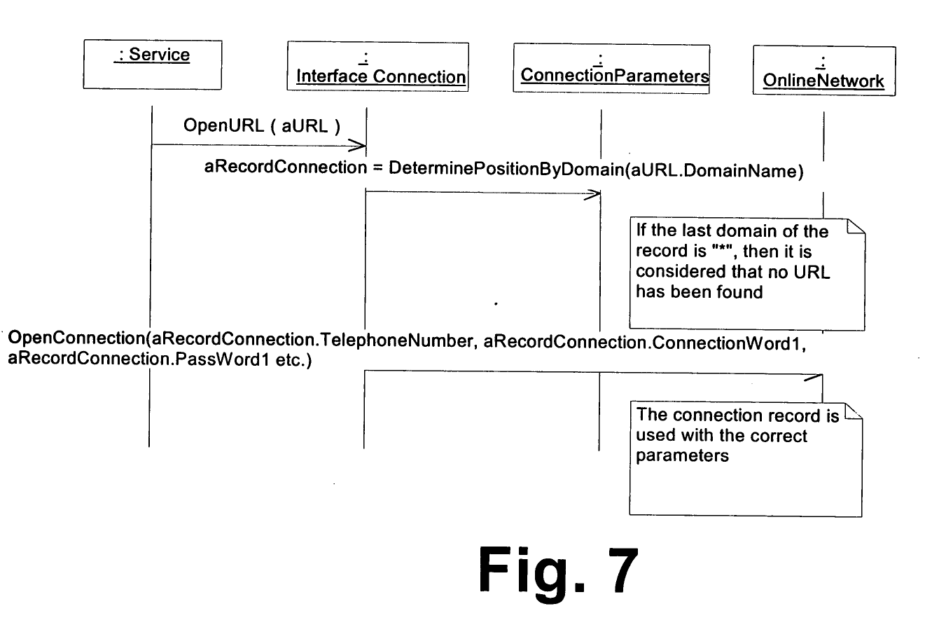

FIG. 7 is a scheme illustrating the operations performed in order to extract, from a URL received, the connection parameters, such as telephone number, connection word, password, server name, etc. through the connection interface.

To make the connection procedure secure, it is proposed within the framework of the exemplary embodiment that no telephone number and authentication parameter or other connection parameter be manipulated directly, but that an interface be built enabling developers to manipulate only URLs, the latter indicating through the domain name used, the telephone number and the authentication parameters to be used.

By passing the domain name through a call to the function of an interface, this domain name is analysed, the configuration to be used is deduced therefrom and the browser's configuration file is then updated, as illustrated in FIG. 3.

The process implemented takes place in the following way:

The relevant service comprises a call to the function of the connection interface (function designated here under the reference ‘OpenURL’). The connection interface then proceeds to the analysis of the parameter of the function (here a URL) and deduces a domain name therefrom. A correspondence file comprises for all the appropriate domain names, and for each domain name the connection parameters (for example telephone number, authentication parameters in particular, etc.). These parameters are used to update the browser's configuration file ‘Configuration.xml’. The initialization of the connection is then ordered by the connection interface at the browser level, by generating an HTML instruction of the same type as that present in the HTML page of FIG. 2.

According to the present exemplary embodiment, the correspondence file is stored in the receiver during the manufacturing phase. According to a variant embodiment, it is sent to the receiver in a secure manner by the transmitter.

The connection interface is according to the present example a ‘JavaScript’ structure drawing inspiration from the object-oriented model in which the developer manipulates an object, attributes and methods.

FIG. 4 illustrates the operations to be performed involving a resident service when an on-line service is to be launched. The resident service, initially active in FIG. 4, opens an instance of the connection interface, then calls the OpenURL function already mentioned in conjunction with FIG. 3. The configuration file is then updated as already explained, then a connection initialization command is sent to the corresponding service (the browser within the framework of the present example). Once the connection has been established, the on-line service is started up and the resident service is shut down. The interactive module ensures that one and only one service is executed at a given moment.

FIG. 5 illustrates the operations to be performed involving a radio broadcast service when an on-line service is to be launched. They take place in a similar manner to that of FIG. 4.

FIG. 6 illustrates the operation to be performed in order to change on-line interactive service when one is already connected to another service of this type. In this case, it is necessary to check whether the connection parameters of the new service are identical to those of the current service. In particular, one checks whether the new service possesses the same charge rate as the previous one (that is to say the cost of the connection per unit time). If it does, the same connection is used (case illustrated by FIG. 6: the on-line service does not need to call upon the connection interface), if it does not, there is disconnection, then reconnection. As this figure shows, only the last part of the script present in the OpenURL function is invoked: window.location=aURL.

FIG. 7 is a diagram of the operations performed in order to extract, from a URL received, the connection parameters, such as telephone number, connection word, password, server name, etc. through the connection interface.

Once activated, the connection interface compares the domain names in its correspondence file with the domain name deduced from the URL. If a correspondence is found, everything occurs as described above in conjunction with FIG. 2. If the connection interface reaches the end of the list of the correspondence file (domain ‘*’) default values are used to establish the connection.

According to a variant of the invention, there is no default entry in the table, thereby precluding the improper use of a default charge rate. Specifically, from the moment the services operator provides the means to access a resource whose domain name is not present in the correspondence file, he leaves the door open to a competitor who could profit therefrom in order to offer competing services and more attractive tariffs. By blocking the connection in case of failed identification of the charge rate, the services operator guards himself against this problem.

1. Method of establishing a connection between an interactive device and an interactive services server, characterized in that it comprises the steps, at the level of the said interactive device of:
determining a domain identifier;
searching for the domain identifier in a correspondence file comprising a plurality of domain identifiers and for each domain identifier connection parameters;
updating a connection configuration file for an application with the aid of the connection parameters corresponding to the domain identifier received;
initializing the connection on the basis of the configuration file.

2. Method according to claim 1, characterized in that the steps of establishing the connection are launched following a call of a function of the receiver by an interactive service, the said function call comprising as a parameter the identifier of the domain to be searched for in the correspondence file.

3. Method according to claim 2, characterized in that the function call is contained in an HTML page processed by browser software of the receiver.

4. Method according to one of claims 1 to 3, characterized in that the determined domain identifier is a URL.

5. Method according to one of claims 1 to 4, characterized in that if no correspondence is found in the correspondence file, then default connection parameters are used for the updating of the configuration file.

6. Receiver in a system for transmitting interactive services, characterized in that it comprises means for storing a correspondence file comprising a list of domain identifiers and for each domain identifier a list of connection parameters corresponding to the relevant domain.

7. Receiver according to claim 6, characterized in that it moreover comprises a configuration file for an application for the establishing of a connection by this application, the configuration file being updated with connection parameters extracted from the correspondence file before the initialization of the connection to be established.
